(19) United States
(12) Patent Application Publication
(10) Pub. No.: US 2021/0339182 A1
(43) Pub. Date: Nov. 4, 2021

(54) MODULARIZED DUST COLLECTOR SYSTEM AND CONTROL METHOD THEREOF

(71) Applicant: ZHEJIANG HONGSHENG NEW MATERIAL TECHNOLOGY GROUP CO., LTD, Quzhou, Zhejiang (CN)

(72) Inventors: Pengze SONG, Quzhou, Zhejiang (CN); Gang LI, Quzhou, Zhejiang (CN); Lianmin SHAO, Quzhou, Zhejiang (CN)

(21) Appl. No.: 17/282,389

(22) PCT Filed: Apr. 23, 2019
(86) PCT No.: PCT/CN2019/083856

§ 371 Date: Apr. 2, 2021

(30) Foreign Application Priority Data
Oct. 26, 2018 (CN) 201811264309.6

(51) Int. Cl. B01D 46/04; B01D 46/00; B01D 46/42; B01D 46/46; B01D 46/44; B01D 46/48

(52) U.S. Cl. CPC B01D 46/04; B01D 46/0006; B01D 46/0043; B01D 46/48; B01D 46/4227; B01D 46/46; B01D 46/446; B01D 46/4263

(57) ABSTRACT

Disclosed are a modularized dust collector system and a control method thereof. In the system, an air inlet and guide device is in communication with a filter device, and comprises a dust inlet channel, a dust guide plate and an airflow uniform-distribution plate; the filter device comprises a dust collector dust-air box and a dust-removing filter bag, and the filter device is of an integrated drawer-type push-pull structure as a whole; an air outlet device is in communication with the filter device, and the air outlet device comprises a dust collector purified air box and an air outlet channel; an ash-removing device is arranged inside the dust collector purified air box; and an ash collecting device is in communication with the filter device, and the ash collecting device has an upper region being provided with an ash hopper, and a lower region therein being provided with an ash conveying mechanism.

The present application claims the priority to Chinese Patent Application No. 201811264309.6, titled “MODULARIZED DUST COLLECTOR SYSTEM AND CONTROL METHOD THEREOF”, filed with the China National Intellectual Property Administration on Oct. 26, 2018, which is incorporated herein by reference in its entirety.

### FIELD

The present application relates to the technical field of train dust collectors, in particular to a modularized dust collector system and a control method thereof.

### BACKGROUND

A bag filter is a kind of dry dust filter, which uses a bag filter element made of fabric to collect solid particles in dusty gas, and is suitable for collecting fine, dry and non-fibrous dust. With the appearance of new filter materials and various forms of automatic dust removal, this kind of dust removal equipment with a history of more than 100 years is becoming more and more perfect, and it is widely used in modern industrial dust removal.

In the electric power, petrochemical, metallurgy, steel, cement and other industries, the bag filter is applied more and more widely. Most of the components of the dust collector need to be transported to a local area, assembled on site. Thus its entire workload on site is huge, and its installation period is more than three months. Due to the limitation of on-site working conditions, the construction quality is easily affected, and the on-site working efficiency is reduced. Moreover, some auxiliary equipment need to be transported to the site for assembly before installation, and need to be dismantled and transported away from the site after installation, resulting in a large amount of labor and material consumption. At the same time, it may have a great impact on the normal production and life of the owners at the working condition site and increase the risk. This method not only has low efficiency, long construction period, high cost and large floor area, but also has difficulty to ensure the accuracy of installation, thus seriously affecting the dust removal effect of the dust collector.

At the same time, the maintenance of the existing dust collector system is relatively cumbersome, especially the filter bag replacement of the filter unit, the bag cage and filter bag need to be drawn out one by one from the dust collector, and then a new filter bag is replaced. The long maintenance period and long replacement time of the filter bag seriously affect the normal production. In addition, the existing dust removal method of the external filter bag dust collector is mainly a pulse jet bag dust collector. The dust removal method of the pulse jet bag dust collector is to blow the filter bag with high pressure air of 0.2-0.5 Mpa at a high speed, so that the filter bag generates pulse expansion vibration from the inside to the outside, and the outer surface of the filter bag obtains a large acceleration, thus shaking off the dust layer on the surface, This dust removal method has good dust removal effect, but it has the problems of high dust removal pressure and short filter bag life.

Therefore, how to provide a modularized dust collector system and a control method thereof, which may save time and cost, improve efficiency, and ensure the dust removal effect, has become a technical problem urgently needed to be addressed by those skilled in the art.

### SUMMARY

An object of the present application is to provide a modularized dust collector system and a control method thereof, which solves the technical problems of low efficiency, long construction period and high cost of the existing dust collector.

The present application provides a modularized dust collector system, including an air inlet guide device, a filtering device, a dust removal device, an air outlet device and a dust collecting device; the air inlet guide device is communicated with the filtering device, the air inlet guide device adopts a box structure, and includes a smoke dust inlet channel, a smoke dust guide plate and an air flow distribution plate, the smoke dust guide plate and the air flow distribution plate are arranged in the smoke dust inlet channel; the filtering device includes a dust collector dust gas box, and a dust filter bag arranged inside the dust collector dust gas box; the filtering device is an integrated drawer-type push-pull structure as a whole; the air outlet device is in communication with the filtering device, and the air outlet device includes a dust collector clean air box, and an air outlet channel arranged inside the dust collector clean air box; the dust removal device is arranged in the dust collector clean air box, and the dust removal device includes a blowback structure and a blow pipe connected to the blowback structure; the dust collecting device is in communication with the filtering device, and the dust collecting device adopts a box structure; a dust hopper is provided in an upper area of the box structure, and a dust conveying mechanism is provided in the lower area of the box structure.

In practical application, an entrance of the smoke dust inlet channel of the air inlet guide device is of a bell mouth structure; the smoke dust guide plate adopts an equal air volume variable diameter structure, and the air flow distribution plate is arranged at a smoke dust outlet.

The air flow distribution plate of the air inlet guide device includes multiple air flow distribution plates, and the multiple air flow distribution plates are evenly spaced apart along the length direction of the smoke dust inlet channel.

In actual application, the filtering device includes multiple dust filter bags, and the multiple dust filter bags are arranged in a bag cage, and the bag cage is arranged in the dust collector dust gas box.

In actual application, the air outlet device further includes a low-temperature heat exchanger, the low-temperature heat exchanger is located at an outlet of the dust collector clean air box and is used for heat recovery and utilization.

The low-temperature heat exchanger of the air outlet device is provided with PTFE pipes and heat conducting media therein.

In actual application, the dust removal device further includes an ultrasonic auxiliary dust cleaner, the ultrasonic auxiliary dust cleaner converts the kinetic energy of the pressure gas into the fluctuating energy of the sound wave, and uses the fluctuating energy of the sound wave to achieve the purpose of removing dust.

In actual application, the blowback structure is connected with the sliding track in a sliding way, and a driving mechanism is arranged, and the driving mechanism is used for driving the blowback structure to move along the sliding track, so that the blow pipe may be communicated with the dust filter bag in turn.

The dust conveying method of the dust conveying mechanism of the dust collecting device adopts pneumatic conveying.

Compared with the conventional technology, the modularized dust collector system of the present application has the following advantages.

The modularized dust collector system provided by the present application includes the air inlet guide device, the filtering device, the dust removal device, the air outlet device and the dust collecting device; the air inlet guide device is communicated with the filtering device, the air inlet guide device adopts a box structure, and includes the smoke dust inlet channel, the smoke dust guide plate and the air flow distribution plate, and the smoke dust guide plate and the air flow distribution plate are arranged in the smoke dust inlet channel; the filtering device includes the dust collector dust gas box, and the dust filter bag arranged inside the dust collector dust gas box; the filtering device is the integrated drawer-type push-pull structure as a whole; the air outlet device is in communication with the filtering device, and the air outlet device includes the dust collector clean air box, and the air outlet channel arranged inside the dust collector clean air box; the dust removal device is arranged in the dust collector clean air box, and the dust removal device includes the blowback structure and the blow pipe connected to the blowback structure; the dust collecting device is in communication with the filtering device, and the dust collecting device adopts a box structure. The dust hopper is provided in the upper area of the box structure, and a dust conveying mechanism is provided in the lower area of the box structure.

When the modularized dust collector system provided by the present application is used, dust-containing flue gas first passes through the smoke dust inlet channel, the smoke dust guide plate and the air flow distribution plate of the air inlet guide device, and then the dust-containing flue gas uniformly enters the filtering device, during which a part of large-particle dust falls directly into the dust hopper of the dust collecting device due to gravity and interception in the air inlet guide device; in the dust gas box of the dust collector of the filtering device, a pressure difference is formed inside and outside the dust filter bag, air flows into the dust filter bag, dust is intercepted by the dust filter bag, and is filtered and resides on the outer surface of the dust filter bag, clean gas enters the dust collector clean gas box of the air outlet device through the mouth of the dust filter bags, and then is discharged through the air outlet channel of the air outlet device to realize gas-solid separation; after dust accumulated on the surface of dust filter bag to a certain extent, the pressure difference inside and outside the filter bag may rise. When the pressure difference reaches the set value or after the set time, the dust removal device may clean the dust filter bag, and the blowback structure and the blow pipe may blow the dust accumulated on the surface of the dust filter bag with steering flow, so as to realize the regeneration of the dust filter bag; the dust cleared by the dust removal device falls into the dust hopper of the dust collecting device, and passes through the dust conveying mechanism of the dust collecting device to convey the dust collected in the dust hopper to the designated area.

From this analysis, it may be seen that the modularized dust collector system provided by the present application may be assembled and produced in a modular manner by a factory because the air inlet guide device, the filtering device, the air outlet device and the dust collecting device all adopt a box structure, and may be assembled into a combined bag dust collector, that is, a modularized dust collector system according to field application requirements, thereby saving time and cost and improving efficiency; the air inlet guide device is communicated with the filtering device, the dust removal device is used for removing dust accumulated on the surface of the filter bag in the filtering device, and the filtering device is respectively communicated with the air outlet device and the dust collecting device, thereby effectively ensuring the dust removal effect. The modularized dust collector system provided by the present application adopts the structural form of the container standard modularized dust collector, thereby facilitating transportation and installation, greatly reducing the workload of transportation and on-site hoisting, splicing, welding and the like, effectively shortening the construction period, improving the work efficiency and reducing the installation cost; meanwhile, the air inlet guide device, the filtering device, the air outlet device and the dust collecting device are in the form of independent units, so that the number of independent units of the dust collector may be selectively used according to actual needs, thus saving space and occupying a small area.

The present application further provides a control method of modularized dust collector system, and dust-containing flue gas first passes through the smoke dust inlet channel, the smoke dust guide plate and the air flow distribution plate of the air inlet guide device, and then the dust-containing flue gas uniformly enters the filtering device, during which a part of large-particle dust falls directly into the dust hopper of the dust collecting device due to gravity and interception in the air inlet guide device; in the dust gas box of the dust collector of the filtering device, a pressure difference is formed inside and outside the dust filter bag, air flows into the dust filter bag, dust is intercepted by the dust filter bag, and is filtered and resides on the outer surface of the dust filter bag, clean gas enters the dust collector clean air box of the air outlet device through the mouth of the dust filter bags, and then is discharged through the air outlet channel of the air outlet device to realize gas-solid separation. After dust accumulated on the surface of dust filter bag to a certain extent, the pressure difference inside and outside the filter bag may rise. When the pressure difference reaches the set value or after the set time, the dust removal device may clean the dust filter bag, and the blowback structure and the blow pipe may blow the dust accumulated on the surface of the dust filter bag with steering flow, so as to realize the regeneration of the dust filter bag. The dust cleared by the dust removal device falls into the dust hopper of the dust collecting device, and passes through the dust conveying mechanism of the dust collecting device to convey the dust collected in the dust hopper to a designated area.

The control method of the modularized dust collector system has the same advantages as the foregoing modularized dust collector system over the conventional technology, and is not repeated here.

### BRIEF DESCRIPTION OF THE DRAWINGS

The drawings to be used in the description of the embodiments or the conventional technology will be described briefly as follows, so that the technical solutions according to the embodiments of the present application or according to the conventional technology will become clearer. It is apparent that the drawings in the following description only illustrate some embodiments of the present application. For those skilled in the art, other drawings may be obtained according to these drawings without any creative work.

FIG. 1 is a schematic structural diagram of a modularized dust collector system provided by an embodiment of the present application;

FIG. 2 is a schematic structural diagram of an air inlet guide device in a modularized dust collector system provided by the embodiment of the present application;

FIG. 3 is a schematic structural diagram of another air inlet guide device in a modularized dust collector system provided by the embodiment of the present application;

FIG. 4 is a schematic structural diagram of a filtering device in a modularized dust collector system provided by the embodiment of the present application;

FIG. 5 is a schematic structural diagram of an air outlet device in a modularized dust collector system provided by the embodiment of the present application;

FIG. 6 is a schematic structural diagram of a dust collecting device in a modularized dust collector system provided by the embodiment of the present application;

FIG. 7 is a schematic structural diagram of the modularized dust collector system provided by the embodiment of the present application when the filtering device adopts an integrated drawer-type push-pull structure.

Reference numerals are listed as follows:

| | |
|---|---|
| 2 air inlet guide device, | 21 smoke dust inlet channel, |
| 22 smoke dust guide plate, | 23 air flow distribution plate, |
| 3 filtering device, | 31 dust gas box of a dust collector, |
| 32 dust filter bag, | 33 bag cage, |
| 4 dust removal device, | 41 blowback structure |
| 42 blow pipe, | 5 air outlet device, |
| 51 dust collector clean gas box, | 52 air outlet channel, |
| 6 dust collecting device, | 61 dust hopper, |
| 62 dust conveying mechanism. | |

### DETAILED DESCRIPTION OF THE EMBODIMENTS

The technical solutions according to the embodiments of the present application will be described clearly and completely as follows in conjunction with the drawings. It is apparent that the described embodiments are only a part of the embodiments according to the present application, rather than all the embodiments. Any other embodiments obtained by those skilled in the art based on the embodiments in the present application without any creative work fall in the scope of protection of the present application.

In the description of the present application, it should be noted that the orientation or positional relationships indicated by terms such as “center”, “up”, “down”, “left”, “right”, “vertical”, “horizontal”, “inner”, “outer”, and the like are based on the orientation or positional relationships shown in the drawings, and are merely for the convenience of describing the present application and the simplification of the description, and do not indicate or imply that the system or element referred to must have a particular orientation, or be configured and operated in a particular orientation, and therefore should not be construed as a limitation to the scope of the present application. In addition, the terms “first”, “second”, “third” and the like are only for purpose of description, and should not be construed as indicating or implying relative importance.

In the description of the present application, it should be noted that, otherwise clear specification and definition are provided, terms such as “installation”, “joint” and “connection” should be understood in a broad sense, such as a fixed connection, a detachable connection or an integral connection; a mechanical connection or an electrical connection; a direct connection or an indirect connection through an intermediate media, or an internal connection inside two components. For those skilled in the art, the specific meaning of the above terms in the present application may be understood in the light of specific circumstances.

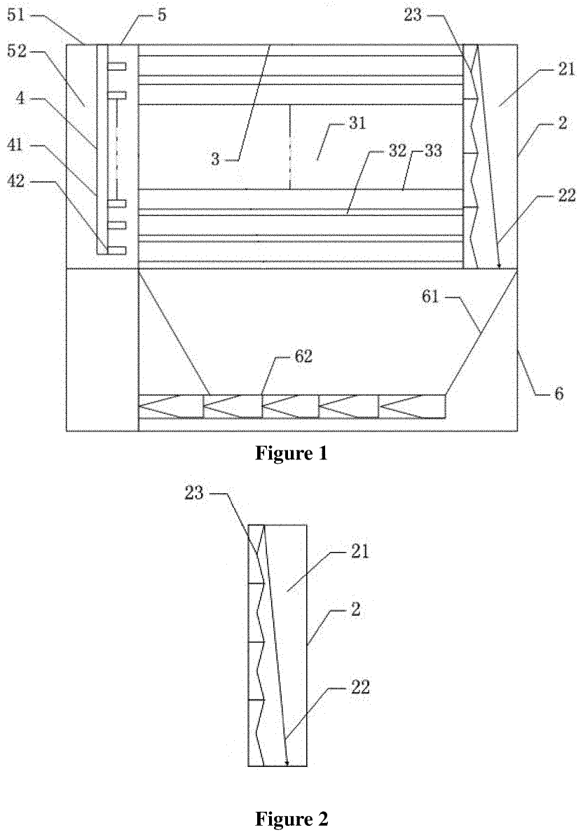

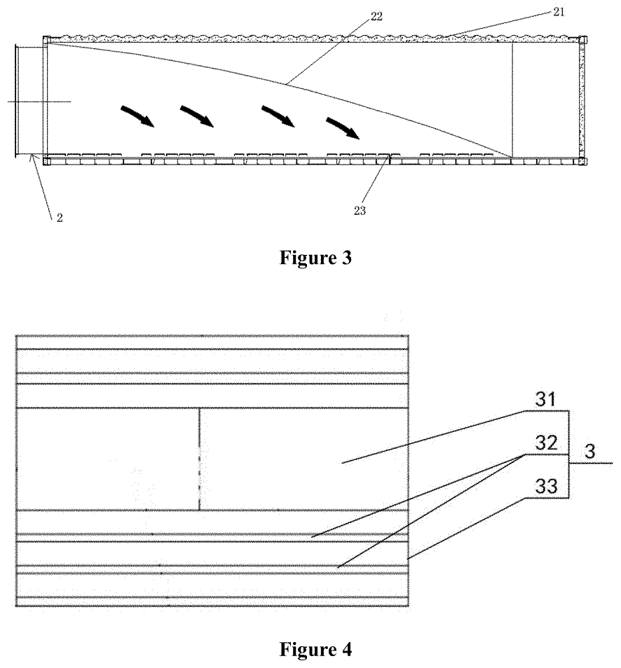

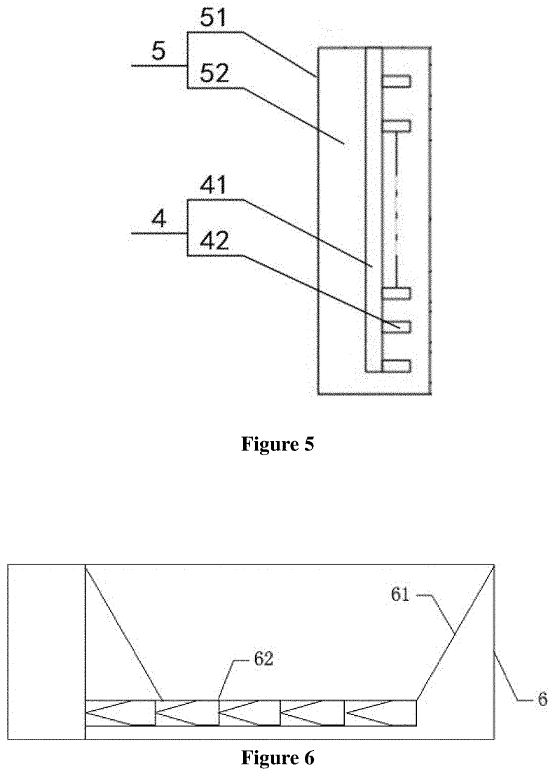

FIG. 1 is a schematic structural diagram of a modularized dust collector system provided by an embodiment of the present application; FIG. 2 is a schematic structural diagram of an air inlet guide device in the modularized dust collector system provided by the embodiment of the present application; FIG. 3 is a schematic structural diagram of another air inlet guide device in the modularized dust collector system provided by the embodiment of the present application; FIG. 4 is a schematic structural diagram of a filtering device in the modularized dust collector system provided by the embodiment of the present application; FIG. 5 is a schematic structural diagram of an air outlet device in the modularized dust collector system provided by the embodiment of the present application; FIG. 6 is a schematic structural diagram of a dust collecting device in the modularized dust collector system provided by the embodiment of the present application.

As shown in FIG. 1 to FIG. 6, the present application provides a modularized dust collector system, including an air inlet guide device 2, a filtering device 3, a dust removal device 4, an air outlet device 5 and a dust collecting device 6; the air inlet guide device 2 is communicated with the filtering device 3, the air inlet guide device 2 is of a box structure, and includes a smoke dust inlet channel 21, a smoke dust guide plate 22 and an air flow distribution plate 23, and the smoke dust guide plate 22 and the air flow distribution plate 23 are arranged in the smoke dust inlet channel 21; the filtering device 3 includes a dust collector dust gas box 31, and a dust filter bag 32 arranged inside the dust collector dust gas box 31; in addition, the filtering device 3 is an integrated drawer-type push-pull structure as a whole; the air outlet device 5 is in communication with the filtering device 3, and the air outlet device 5 includes a dust collector clean air box 51, and an air outlet channel 52 arranged inside the dust collector clean air box 51; the dust removal device 4 is arranged in the dust collector clean air box 51, and the dust removal device 4 includes a blowback structure 41 and a blow pipe 42 connected to the blowback structure 41; the dust collecting device 6 is in communication with the filtering device 3, and the dust collecting device 6 is of a box structure. A dust hopper 61 is provided in an upper area of the box structure, and a dust conveying mechanism 62 is provided in the lower area of the box structure.

Compared with the conventional technology, the modularized dust collector system according to the embodiment of the present application has the following advantages:

the modularized dust collector system provided by the embodiment of the present application, as shown in FIG. 1 to FIG. 6, includes the air inlet guide device 2, the filtering device 3, the dust removal device 4, the air outlet device 5 and the dust collecting device 6; the air inlet guide device 2 is communicated with the filtering device 3, the air inlet guide device 2 is of a box structure, and includes the smoke dust inlet channel 21, the smoke dust guide plate 22 and the air flow distribution plate 23, and the smoke dust guide plate 22 and the air flow distribution plate 23 are arranged in the smoke dust inlet channel 21; the filtering device 3 includes the dust collector dust gas box 31, and the dust filter bag 32 arranged inside the dust collector dust gas box 31; in addition, the filtering device 3 is the integrated drawer-type push-pull structure as a whole; the air outlet device 5 is in communication with the filtering device 3, and the air outlet device 5 includes the dust collector clean air box 51, and the air outlet channel 52 arranged inside the dust collector clean air box 51; the dust removal device 4 is arranged in the dust collector clean air box 51, and the dust removal device 4 includes the blowback structure 41 and the blow pipe 42 connected to the blowback structure 41; the dust collecting device 6 is in communication with the filtering device 3, and the dust collecting device 6 is of a box structure. The dust hopper 61 is provided in the upper area of the box structure, and the dust conveying mechanism 62 is provided in the lower area of the box structure.

When the modularized dust collector system provided by the embodiment of the present application is used, dust-containing flue gas first passes through the smoke dust inlet channel 21, the smoke dust guide plate 22 and the air flow distribution plate 23 of the air inlet guide device 2, and then the dust-containing airflow uniformly enters the filtering device 3, during which a part of large-particle dust falls directly into the dust hopper 61 of the dust collecting device 6 due to gravity and interception in the air inlet guide device 2; in the dust gas box of the dust collector 31 of the filtering device 3, a pressure difference is formed inside and outside the dust filter bag 32, air flows into the dust filter bag 32, dust is intercepted by the dust filter bag 32, and is filtered and resides on the outer surface of the dust filter bag 32, clean gas enters the dust collector clean gas box 51 of the air outlet device 5 through a mouth of the dust filter bag 32, and then is discharged through the air outlet channel 52 of the air outlet device 5 to realize gas-solid separation; after dust accumulated on the surface of dust filter bag 32 to a certain extent, the pressure difference inside and outside the filter bag may rise. When the pressure difference reaches a set value or after a set time, the dust removal device 4 may clean the dust filter bag 32, and the blowback structure 41 and the blow pipe 42 may blow the dust accumulated on the surface of the dust filter bag 32 with steering flow, so as to realize the regeneration of the dust filter bag 32; the dust cleared by the dust removal device falls into the dust hopper 61 of the dust collecting device 6, and passes through the dust conveying mechanism 62 of the dust collecting device 6 to convey the dust collected in the dust hopper 61 to a designated area.

From this analysis, it may be seen that the modularized dust collector system provided by the embodiment of the present application may be assembled and produced in a modular manner by a factory because the air inlet guide device 2, the filtering device 3, the air outlet device 5 and the dust collecting device 6 are all of a box structure, and may be assembled into a combined bag dust collector, that is, a modularized dust collector system according to field application requirements, thereby saving time and cost and improving efficiency; in addition, the air inlet guide device 2 is communicated with the filtering device 3, the dust removal device 4 is used for removing dust accumulated on the surface of the filter bag in the filtering device 3, and the filtering device 3 is respectively communicated with the air outlet device 5 and the dust collecting device 6, thereby effectively ensuring the dust removal effect. The modularized dust collector system provided by the embodiment of the present application adopts the structural form of the container standard modularized dust collector, thereby facilitating transportation and installation, greatly reducing the workload of transportation and on-site hoisting, splicing, welding and the like, effectively shortening the construction period, improving the work efficiency and reducing the installation cost; meanwhile, the air inlet guide device 2, the filtering device 3, the air outlet device 5 and the dust collecting device 6 are in the form of independent units, so that the number of independent units of the dust collector may be selectively used according to actual needs, thus saving space and occupying a small area.

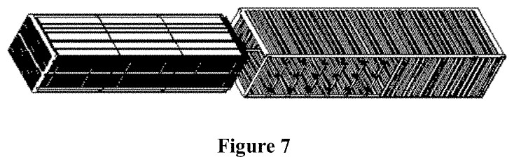

FIG. 7 is a schematic structural diagram of the modularized dust collector system provided by the embodiment of the present application when the filtering device adopts an integrated drawer-type push-pull structure.

It needs to be added here that, as shown in FIG. 7, the dust collector dust gas box 31 may be disposed with a drawer-type frame body, and a roller is arranged on the bottom beam of the box body through a rotating shaft. Meanwhile, multiple beams are arranged and spaced apart at the bottom of the box body, and are slidably assembled into the dust collector dust gas box 31 by the horizontal movable drawer-type frame body and the rollers. A lifting device is arranged at a box outlet of the dust collector dust gas box 31, which is used for lifting the frame body so as to quickly replace a new dust filter bag 32; when the dust collector dust gas box 31 is installed at a relatively high position, it may be complicated when the dust filter bag 32 needs to be replaced and hoisted. Therefore, with the lifting device, it is convenient for the frame body to slide out of the box body and enter the platform of the lifting device, and then the lifting device descends to the ground, so as to replace the dust filter bag 32. After all replacement, the frame body with the new dust filter bag 32 is lifted to the box outlet of the dust collector dust gas box 31 through the lifting device, and then the frame body slides into the box again to realize replacement; the lifting device in this embodiment may be a scissor type lifting platform.

In actual application, as shown in FIG. 2 and FIG. 3, the entrance of the smoke dust inlet channel 21 of the air inlet guide device 2 adopts a bell mouth structure, so that the air flow entering the dust collector may be uniformly diffused.

The smoke dust guide plate 22 adopts a variable diameter structure with equal air volume, so as to ensure that the air flow speed (wind speed) is consistent, and further ensure that the air flow may uniformly enter the filtering device 3. In order to ensure that the airflow speed (wind speed) is consistent, the smoke dust guide plate 22 may be arranged along the length direction of the smoke dust inlet channel 21 and be of an arc shape; or, the smoke dust guide plate 22 may be inclined along the length direction of the smoke dust inlet channel 21.

Specifically, the air flow distribution plate 23 is arranged at the smoke outlet, that is, the air flow distribution plate 23 may be arranged between the smoke dust inlet channel 21 and the filtering device 3.

Further, multiple (e.g., four or five) air flow distribution plates 23 may be provided, and the multiple air flow distribution plates 23 may preferably be evenly spaced apart along the length direction of the smoke dust inlet channel 21, that is, the multiple air flow distribution plates 23 are uniformly spaced apart along the length direction of the smoke dust inlet channel 21.

Furthermore, the dust-containing flue gas may enter from above the filtering device 3 through the smoke dust inlet channel 21, and a direction of the dust precipitation is consistent with the movement direction of the flue gas, thus facilitating the dust precipitation in the dust collecting device during the operation (filtering/cleaning) of the dust collector, and further reducing the probability of “secondary dust raising”. This kind of setting and air inlet method is more effective when dealing with dust-containing flue gas containing more ultrafine dust, and reduces the running resistance of the dust collector equipment.

Alternatively, the dust-containing flue gas may enter from a side of the filtering device 3 through the smoke inlet channel 21. Of course, the air inlet mode is not limited to upper air inlet and side air inlet.

In actual application, as shown in FIG. 4, the filtering device 3 includes multiple dust filter bags 32, and the multiple dust filter bags 32 may be arranged in a bag cage 33 which is arranged in the dust collector dust gas box 31, so that the dust-removing purification effect may be further effectively improved by arranging the multiple dust filter bags 32, and the bag cage 33 is beneficial to replacing the multiple dust filter bags 32 conveniently and quickly.

In actual application, as shown in FIG. 5, the air outlet device 5 further includes a low-temperature heat exchanger (not shown in the figure), which may be located at the outlet of the dust collector clean air box 51 for heat recovery and utilization.

The low-temperature heat exchanger of the air outlet device 5 is provided with PTFE pipes and heat-conducting medium inside, so that good heat recovery is realized through the PTFE, pipes and heat-conducting medium.

It should be added here that Polytetrafluoroethylene (PTFE) is generally called “non-stick coating” or “easy-to-clean material”. This material has the characteristics of acid resistance, alkali resistance and resistance to various organic solvents, and is almost insoluble in all solvents. Meanwhile, PTFE has the characteristics of high temperature resistance, and its friction coefficient is extremely low, so it may be used for lubrication and become an ideal coating for easy cleaning of the inner layer of water pipes.

Specifically, the air outlet channel 52 may adopt an equal air volume variable diameter structure, so that the air flow velocity (wind speed) in the channel may be effectively ensured to be consistent through the equal air volume variable diameter structure.

Further, the air outlet of the air outlet channel 52 may be provided with an electronically controlled regulating valve, so that the air volume may be effectively controlled by the electronically controlled regulating valve.

Furthermore, the air outlet mode may be upward or lateral air outlet; of course, the air outlet mode is not limited to the upward air outlet and the lateral air outlet, and may also be other reasonable forms.

In actual application, as shown in FIG. 5, the dust removal device 4 further includes an ultrasonic auxiliary dust cleaner, the ultrasonic auxiliary dust cleaner converts the kinetic energy of the pressure gas into the fluctuating energy of the sound wave, and uses the fluctuating energy of the sound wave to achieve the purpose of removing dust.

In actual application, as shown in FIG. 6, the blowback structure 41 is connected with the sliding track in a sliding way, and a driving mechanism is arranged, and the driving mechanism is able to drive the blowback structure 41 to move along the sliding track, so that the blow pipe 42 is communicated with the dust filter bags 32 in turn.

Specifically, the driving mechanism may include a motor, a lead screw and a moving block; the lead screw is arranged in the sliding track, the motor is connected with one end of the lead screw through a coupling, another end of the lead screw is rotationally connected with a baffle in the length direction of the sliding track through a bearing, a screw hole is arranged in the moving block for being cooperated and connected with the lead screw, and the moving block is also connected with a connecting part of the blowback structure 41. The motor drives the lead screw to rotate through the coupling to make the moving block move linearly, and the moving block drives the blow pipe 42 to move through the connecting part, so that the blow pipe 42 may blow the dust filter bags 32 in sequence, thus achieving the purpose of high-efficiency dust removal.

Preferably, two sliding tracks may be provided, and the two sliding tracks are arranged at the positions of the two ends of the blowback structure 41; the function of the two sliding tracks is to ensure a stable support. The sliding track may be preferably set in a U-shape, and the middle part of the sliding track is used for accommodating the lead screw and the moving block; two ends of the connecting part are respectively connected with the U-shaped sliding track, the middle part of the connecting part is fixedly connected with the moving block. When the lead screw drives the connecting block to move along the length direction of the lead screw and the sliding track, the moving block may drive the connecting part and the blowback structure 41 to move along the length direction of the sliding track, so that the blow pipe 42 passes through each row of the dust filter bags 32 in turn, and gradually cleans the dust.

The dust conveying method of the dust conveying mechanism 62 of the dust collecting device 6 adopts pneumatic conveying, thereby effectively saving costs through pneumatic conveying and ensuring a good dust conveying effect.

The embodiment of the present application further provides a control method of a modularized dust collector system, dust-containing flue gas first passes through the smoke dust inlet channel 21, the smoke dust guide plate 22 and the air flow distribution plate 23 of the air inlet guide device 2, and then the dust-containing airflow uniformly enters the filtering device 3, during which a part of large-particle dust falls directly into the dust hopper 61 of the dust collecting device 6 due to gravity and interception in the air inlet guide device 2; in the dust gas box of the dust collector 31 of the filtering device 3, a pressure difference is formed inside and outside the dust filter bag 32, air flows into the dust filter bag 32, dust is intercepted by the dust filter bag 32, filtered and resides on the outer surface of the dust filter bag 32, clean gas enters the dust collector clean gas box 51 of the air outlet device 5 through the dust filter bag 32 mouth, and then is discharged through the air outlet channel 52 of the air outlet device 5 to realize gas-solid separation; after dust accumulated on the surface of dust filter bag 32 to a certain extent, the pressure difference inside and outside the filter bag may rise. When the pressure difference reaches the set value or after the set time, the dust removal device 4 may clean the dust filter bag 32, and the blowback structure 41 and the blow pipe 42 may blow the dust accumulated on the surface of the dust filter bag 32 with steering flow, so as to realize the regeneration of the dust filter bag 32; the dust cleared by the dust removal device falls into the dust hopper 61 of the dust collecting device 6, and passes through the dust conveying mechanism 62 of the dust collecting device 6 to convey the dust collected in the dust hopper 61 to the designated area.

The modularized dust collector system and the control method thereof provided by the embodiment of the present application mainly have the following advantages:

1. the workload of on-site hoisting, splicing and welding by more than 90% is reduced, and the on-site installation is simple and easy;

2. the construction period by more than 80% is effectively shortened, the working efficiency is improved and the installation cost is reduced;

3. the occupied space is small, the transportation is convenient, and the occupied area is reduced by more than one third;

4. the number of modularized dust collectors may be adjusted according to the actual processing air volume;

5. the dust removal medium adopts clean flue gas, and the dust removal air volume is internal circulation to softly remove the dust, which may not increase the load on the induced draft fan; at the same time, it solves the problems of dust filter bag damage, condensation and oxidation caused by the dust removal medium, and extends the sevice life of the filter cloth.

The above is only a preferred embodiment of the present application, and is not intended to limit the present application. Any modifications, equivalent substitutions, improvements made within the spirit and principles of the present application should be included in the scope of protection of the present application.

What is claimed is:

1. A modularized dust collector system, comprising an air inlet guide device, a filtering device, a dust removal device, an air outlet device and a dust collecting device;
wherein the air inlet guide device is communicated with the filtering device, the air inlet guide device is of a box structure, and includes a smoke dust inlet channel, a smoke dust guide plate and an air flow distribution plate, and the smoke dust guide plate and the air flow distribution plate are arranged in the smoke dust inlet channel; and
the filtering device comprises a dust collector dust gas box, and a dust filter bag arranged inside the dust collector dust gas box; the filtering device is an integrated drawer-type push-pull structure as a whole; and
the air outlet device is in communication with the filtering device, and the air outlet device includes a dust collector clean air box, and an air outlet channel arranged inside the dust collector clean air box; and
the dust removal device is arranged in the dust collector clean air box, and the dust removal device includes a blowback structure and a blow pipe connected to the blowback structure; and
the dust collecting device is in communication with the filtering device, and the dust collecting device is of a box structure; a dust hopper is provided in an upper area of the box structure, and a dust conveying mechanism is provided in a lower area of the box structure.

2. The modularized dust collector system according to claim 1, wherein an entrance of the smoke dust inlet channel of the air inlet guide device is of a bell mouth structure; and
the smoke dust guide plate is of an equal air volume variable diameter structure, and the air flow distribution plate is arranged at a smoke dust outlet.

3. The modularized dust collector system according to claim 1, wherein the air flow distribution plate of the air inlet guide device comprises a plurality of air flow distribution plates, and the plurality of air flow distribution plates is spaced apart along the length direction of the smoke dust inlet channel.

4. The modularized dust collector system according to claim 1, wherein the dust filter bag of the filtering device comprises a plurality of dust filter bags, and the plurality of dust filter bags is arranged in a bag cage, and the bag cage is arranged in the dust collector dust gas box.

5. The modularized dust collector system according to claim 1, wherein the air outlet device further comprises a low-temperature heat exchanger, the low-temperature heat exchanger is located at an outlet of the dust collector clean air box and is used for heat recovery and utilization.

6. The modularized dust collector system according to claim 5, wherein the low-temperature heat exchanger of the air outlet device is provided with PTFE pipes and heat conducting media therein.

7. The modularized dust collector system according to claim 1, wherein the dust removal device further comprises an ultrasonic auxiliary dust cleaner, the ultrasonic auxiliary dust cleaner converts the kinetic energy of the pressure gas into the fluctuating energy of the sound wave, and uses the fluctuating energy of the sound wave to achieve the purpose of removing dust.

8. The modularized dust collector system according to claim 1, wherein the blowback structure is connected with the sliding track in a sliding way, and a driving mechanism is arranged, and the driving mechanism is used for driving the blowback structure to move along the sliding track, and the blow pipe is communicated with the dust filter bags in turn.

9. The modularized dust collector system according to claim 1, wherein a dust conveying method of the dust conveying mechanism of the dust collecting device is pneumatic conveying.

10. A control method of a modularized dust collector system, wherein dust-containing flue gas first passes through a smoke dust inlet channel, a smoke dust guide plate and an air flow distribution plate of an air inlet guide device, and then the dust-containing flue gas uniformly enters a filtering device, during which a part of large-particle dust falls directly into the dust hopper of the dust collecting device due to gravity and interception in the air inlet guide device; and
in a dust collector dust gas box of the filtering device, a pressure difference is formed inside and outside a dust filter bag, the dust-containing flue gas flows into the dust filter bag, dust is intercepted by the dust filter bag, and is filtered and resides on the outer surface of the dust filter bag, clean gas enters the dust collector clean air box of an air outlet device through a dust filter bag mouth, and then is discharged through an air outlet channel of the air outlet device to realize gas-solid separation; and
after dust accumulated on the outer surface of dust filter bag to a certain extent, the pressure difference inside and outside the filter bag rises; when the pressure difference reaches a set value or after a set time, the dust removal device cleans the dust filter bag, and the blowback structure and the blow pipe blows the dust accumulated on the outer surface of the dust filter bag with steering flow, which realizes the regeneration of the dust filter bag; and
the dust cleaned by the dust removal device falls into a dust hopper of the dust collecting device, and passes through a dust conveying mechanism of the dust collecting device to convey the dust collected in the dust hopper to a designated area.

11. The modularized dust collector system according to claim 2, wherein the air flow distribution plate of the air inlet guide device comprises a plurality of air flow distribution plates, and the plurality of air flow distribution plates is spaced apart along the length direction of the smoke dust inlet channel.

12. The modularized dust collector system according to claim 8, wherein a dust conveying method of the dust conveying mechanism of the dust collecting device is pneumatic conveying.
